(19) United States
(12) Patent Application Publication
(10) Pub. No.: US 2015/0347977 A1
(43) Pub. Date: Dec. 3, 2015

(54) OPTIMIZING WELLNESS PROGRAM SPENDING

(71) Applicant: ORACLE INTERNATIONAL CORPORATION, Redwood Shores, CA (US)

(72) Inventors: Nigel KING, San Mateo, CA (US); Michal MELAMUD, San Mateo, CA (US)

(73) Assignee: ORACLE INTERNATIONAL CORPORATION, Redwood Shores, CA (US)

(21) Appl. No.: 14/293,919

(22) Filed: Jun. 2, 2014

(51) Int. Cl. G06Q 10/10; G06N 99/00; G06N 5/04; G06Q 40/00

(52) U.S. Cl. CPC G06Q 10/1057; G06Q 40/12; G06N 99/005; G06N 5/04

(57) ABSTRACT

A method, system, and computer program product for managing employee wellness incentive programs. Some embodiments commence by accessing databases to retrieve a set of wellness program spending amount datapoints, and then organizing those datapoints into a series of successively increasing wellness program spending amounts. The wellness program spending amounts are historical amounts or prospective amounts. A calculator or predictor generates a respective series of wellness program savings amounts, wherein individual ones of the series of the wellness program savings amounts comprise at least calculated or predicted healthcare cost savings. A net benefit is determined and used as a desired wellness program spending amount. The desired wellness program spending amount is the spending amount at which point an incremental amount of additional wellness program spending results in only an equal or lesser amount of incremental calculated or predicted wellness program savings. Wellness incentive spending can be accordingly adjusted up or down.

### RELATED APPLICATIONS

The present application is related to co-pending U.S. patent application Ser. No. 14/293,890, entitled, “USING CROWDSOURCING CONSENSUS TO DETERMINE NUTRITIONAL CONTENT OF FOODS DEPICTED IN AN IMAGE” (Attorney Docket No. ORA140467-US-NP), filed on even date herewith; and the present application is related to co-pending U.S. patent application Ser. No. ______, entitled “FORMING RECOMMENDATIONS USING CORRELATIONS BETWEEN WELLNESS AND PRODUCTIVITY” (Attorney Docket No. ORA140676-US-NP), filed on even date herewith, each of which are hereby incorporated by reference in their entirety.

### FIELD

The disclosure relates to the field of managing employee wellness incentive programs and more particularly to techniques for optimizing wellness program spending to maximize wellness program benefits with respect to the wellness program spending.

### BACKGROUND

Increasingly, corporate-sponsored employee benefit programs include a “wellness” component. Often such a wellness component includes employee incentives that are intended to encourage healthy behaviors. For example, an employer might encourage employees to walk more by providing “free” pedometers (for measurement) and awarding an employee $100 if their pedometer accounts for 7000 steps in a particular week. In addition to altruistic motives corporate-sponsored employee benefit programs are formed and administered on data suggesting that a healthier workforce incurs fewer absences, enjoys lower health insurance premiums, and on average, is more productive than a workforce that does not accrue the benefits of a wellness program. Yet, forming and administering a corporate-sponsored employee benefit program has direct costs, and such direct costs are accounted for as an expense. As such, the employee wellness program expense is tallied to the bottom line. Thus, while employees would generally support more and more corporate sponsorship (e.g., more incentives, more spending) shareholders would tend to have a limit.

More spending on a wellness program (e.g., wellness incentives) tend to increase participation, leading to a healthier workforce. Yet, such spending can become progressively less and less effective as participation reaches saturation. Further, spending beyond a saturation point such as where participation levels stall may turn out to be spending that does not yield a commensurate return. Unfortunately, legacy models fail to provide techniques for determining saturation points or stall points and/or determining the relationships between wellness-attributed spending and corresponding wellness-attributed benefits. Thus, legacy techniques fail to aid the business manager to know how much to spend on a wellness program.

What is needed is a way to determine the point at which one more unit of wellness program promotion (e.g., wellness promotion as measured in dollars) returns one more unit of wellness-attributed benefits (e.g., productivity as measured in dollars, or lower healthcare premium costs, etc.).

None of the aforementioned legacy approaches achieve the capabilities of the herein-disclosed techniques for determining wellness program spending to maximize wellness program benefits. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for determining wellness program spending to maximize wellness program benefits.

Some embodiments commence by accessing a database to retrieve a set of wellness program spending amount data points, and organizing those points in a series of successively increasing wellness program spending amounts. The wellness program spending amounts are historical amounts or prospective amounts. A calculator or predictor generates a respective series of wellness program savings amounts, wherein individual ones of the series of the wellness program savings amounts comprise calculated or predicted healthcare costs. A net benefit is determined and used as a desired wellness program spending amount. The desired wellness program spending amount is the spending amount at which point an incremental amount of additional wellness program spending results in only an equal or lesser amount of incremental calculated or predicted wellness program savings.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1 is an environment for measuring and determining wellness program spending to maximize wellness program benefits, according to some embodiments.

FIG. 2A is a chart to model a participation rate as a function of motivational wellness incentive spending as used in systems for determining wellness program spending to maximize wellness program benefits, according to some embodiments.

FIG. 2B is a chart to model a productivity as a function of direct wellness incentive spending as used in systems for determining wellness program spending to maximize wellness program benefits, according to some embodiments.

FIG. 3 is a chart to model a wellness index as a function of indirect wellness incentive spending as used in systems for determining wellness program spending to maximize wellness program benefits, according to some embodiments.

FIG. 4A is a chart to model changing healthcare premium costs as a function of a wellness index as used in systems for determining wellness program spending to maximize wellness program benefits, according to some embodiments.

FIG. 4B is a chart to model changing employee productivity as a function of a wellness index as used in systems for determining wellness program spending to maximize wellness program benefits, according to some embodiments.

FIG. 5A is a system for calculating net return as a function of wellness program spending as used in systems for determining wellness program spending to maximize wellness program benefits, according to some embodiments.

FIG. 5B is a chart depicting net return as a function of wellness program spending as used in systems for determining wellness program spending to maximize wellness program benefits, according to some embodiments.

FIG. 6 is a block diagram depicting a program optimizer module as used in systems for determining wellness program spending to maximize wellness program benefits, according to some embodiments.

FIG. 7A is a block diagram depicting a learning module as used in systems for determining wellness program spending to maximize wellness program benefits, according to some embodiments.

FIG. 7B is a block diagram depicting a simulation model-based predictor as used in systems for determining wellness program spending to maximize wellness program benefits, according to some embodiments.

FIG. 8 is a block diagram of a system for determining wellness program spending to maximize wellness program benefits, according to some embodiments.

FIG. 9 is a block diagram of a system for determining wellness program spending to maximize wellness program savings, according to some embodiments.

FIG. 10 depicts a block diagram of an instance of a computer system suitable for implementing an embodiment of the present disclosure.

### DETAILED DESCRIPTION

Disclosed herein and in the accompanying figures are exemplary environments, methods, and systems for determining wellness program spending to maximize wellness program benefits.

### Overview

More spending on a wellness program (e.g., wellness incentives) tend to increase participation, leading to a healthier workforce. Yet, such spending can become progressively less and less effective as participation reaches saturation. Further, spending beyond a saturation point such as where participation levels stall may turn out to be spending that does not yield a commensurate return. Unfortunately, legacy models fail to provide techniques for determining points of diminishing returns or stall points and/or determining the relationships between wellness-attributed spending and corresponding wellness-attributed benefits. Thus, legacy techniques fail to aid the business manager to know how much to spend on a wellness program.

What is needed is a way to determine the point at which one more unit of wellness program promotion (e.g., wellness promotion as measured in dollars) returns one more unit of wellness-attributed benefits (e.g., productivity as measured in dollars).

In an enterprise setting, spending and productivity are tracked. For example, spending is tracked down to the granularity of one dollar. Aggregate productivity is measured in terms of profits, and in some cases (e.g., in a manufacturing setting) some aspects of productivity are measured or measurable directly, such as units of production or labor hours devoted to production. In other cases, certain aspects of productivity are indirectly measured (e.g., in revenue per labor hour, or profit per work hour), and dollar-wise benefits can be correlated to or deemed to be wellness-attributed. For example, the healthcare premium costs for a healthy workforce can be measurably less than the healthcare premium costs for an unhealthy workforce.

In some enterprise settings, spending and dollar-wise benefits are captured in an enterprise-wide database system. And in some cases a model can be developed to help a benefits manager to observe the effects of wellness program incentive spending (e.g., wellness program stimulus of any variety) and assess the impact of such wellness program incentive spending. In some embodiments a cost model helps the benefits manager to forecast and model spending, and a separate wellness-attributed benefit model helps the benefits manager to measure the wellness-attributed productivity gains. Over time, the relationship between wellness measures such as absences and/or healthcare costs can be automatically refined based on historical data. In exemplary embodiments, a learning model accesses historical data comprising historical amounts and/or a learning model component generates prospective spending amounts and correlates observed productivity measures to wellness-attributed stimulation. The learning model is used as a predictor.

Such models can be used by a benefits manager to experiment with a range of and/or mix of wellness spending levels. Ongoing observations and/or a time series of predictions allows the benefits manager to verify the magnitude and correlation between wellness-attributed spending and wellness-attributed productivity.

When an objective function is used (e.g., to maximize benefits of wellness program spending), such a model can recommend an optimal incentive level so as to maximize the benefit to the company.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

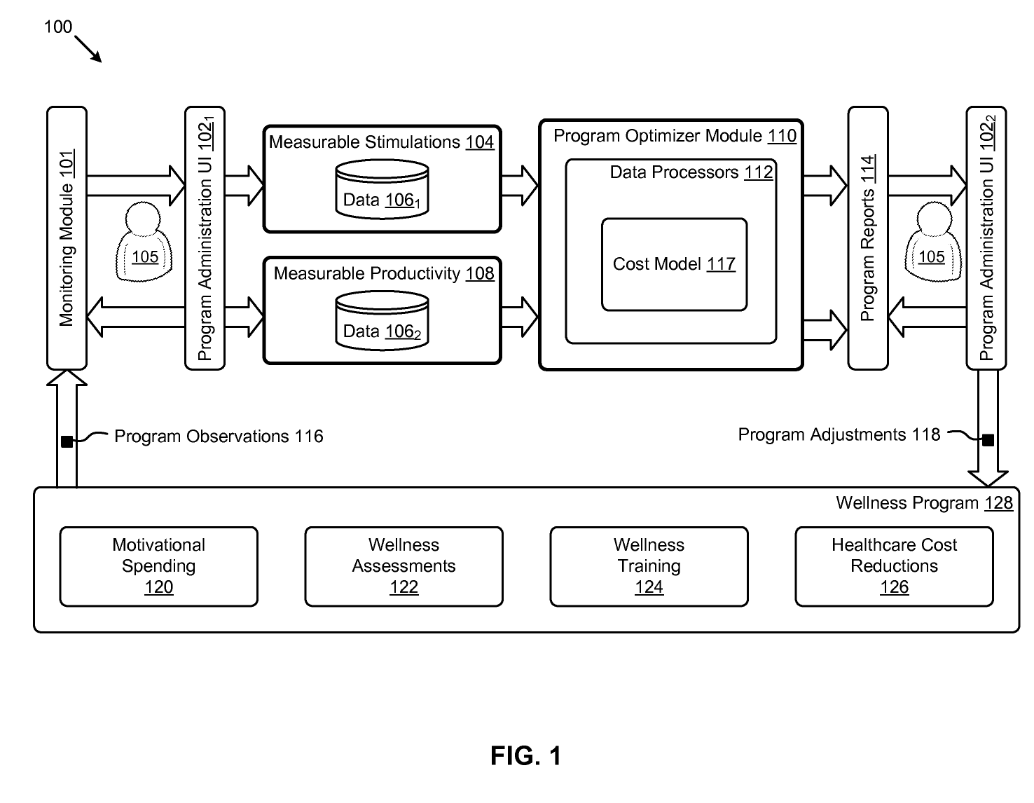

FIG. 1 is an environment 100 for measuring and determining wellness program spending to maximize wellness program benefits. As an option, one or more instances of environment 100 or any aspect thereof may be implemented in the context of the architecture and functionality of the embodiments described herein. Also, the environment 100 or any aspect thereof may be implemented in any desired environment.

As shown in FIG. 1, a wellness program 128 is administered by a user 105 (e.g., a benefits program administrator). The user can specify and/or control and/or negotiate the spending and/or performance of various functions within the wellness program. For example, and as shown, a wellness program might include functions such as incentives (e.g., motivational spending 120), employee measurements (e.g., wellness assessments 122), instruction (e.g., wellness training 124) and cost control (e.g., healthcare cost reductions 126). During the course of prosecuting the wellness program, the user 105 interfaces with a user interface (UI) such as the shown program administration UI 102₁. The user interface can specify and/or control collection of and/or usage of various wellness program-related data. In this embodiment, a program optimizer module 110 receives inputs in the form of program stimulations (e.g., measurable stimulations 104). The program stimulations can be stored in a database (e.g., data 106₁) and can be retrieved by the program optimizer module, which in turn can output reports (e.g., program reports 114). The program optimizer module can process received data using any forms of data processors 112, which data processors may include a cost model 117.

In addition to the program stimulations taken in by the program optimizer module, various measures of productivity (e.g., measurable productivity 108) can be processed by the program optimizer module. Measures of productivity might be captured by any known means, including enterprise resource planning systems and/or a human resources system and/or other business applications as might be used in an enterprise. In exemplary environments, such data is managed using one or more database engines comprising any number of database servers. Various formats of such data can be stored in persistent storage such as data 106₂.

The program optimizer module can output various forms of reports, which can be read by a user 105, who can in turn make changes (e.g., program adjustments 118) using the program administration UI 102₂ to effect changes to the makeup and prosecution of the wellness program 128.

The aforementioned measurable stimulation can include various forms of spending or other forms of stimulation. For example, measurable stimulation might include:
Incentives paid to employees for participation in wellness programs.
Paid time off for wellness activities.
Fully-paid or partially paid time for wellness training, wellness-related games, and/or workout time.
On-the-clock pay for motivational moments such as management motivational speaking and/or management feedback sessions.
Subsidization of high nutrition meals in the cafeteria.
Increased subsidization of an employee's share of the employee's health care plan (e.g., a health insurance premiums share or health maintenance organization fee share, or another employee healthcare cost-sharing amount).
Etcetera.

The aforementioned measurable productivity can include direct or indirect measurements based on:
Absences.
Employee productivity measurements based on one or more ratios between headcount and revenue.
Aggregated or holistic productivity, for example, productivity as measured by reduced healthcare premium costs (e.g., resulting from insurance carrier recognition of the fiscal impact arising from the lower incidence of chronic diseases as is found in an active workforce).

Using a system such as is depicted in environment 100, a benefits manager can create a mix of incentives designed to engage employees to the point of participation in a wellness program and, as indicated above, the effect of participation can be measured in terms of real and/or perceived improvements and/or increased wellness or well-being (e.g., see program observations 116), which in turn results in increased individual performance (e.g., greater productivity, fewer absences, etc.), which in turn may result in cost reductions and/or other contributors to improved financial performance. In some situations, such as within environment 100, program observations 116 can be captured and stored in a monitoring module (e.g., monitoring module 101) and program observations and other monitored measurement taken can be presented to a user 105.

Some embodiments include modules beyond those shown in FIG. 1. For example, some environments include multi-dimensional models such as (for example) relationships between incentives and participation, relationships between participation and well-being, relationships between well-being and productivity, relationships between productivity and spending, and other relationships (direct and indirect) between program spending and program benefits. Such relationships can derive, at least in part, from empirical observations (e.g., from data stored in an enterprise resource planning application).

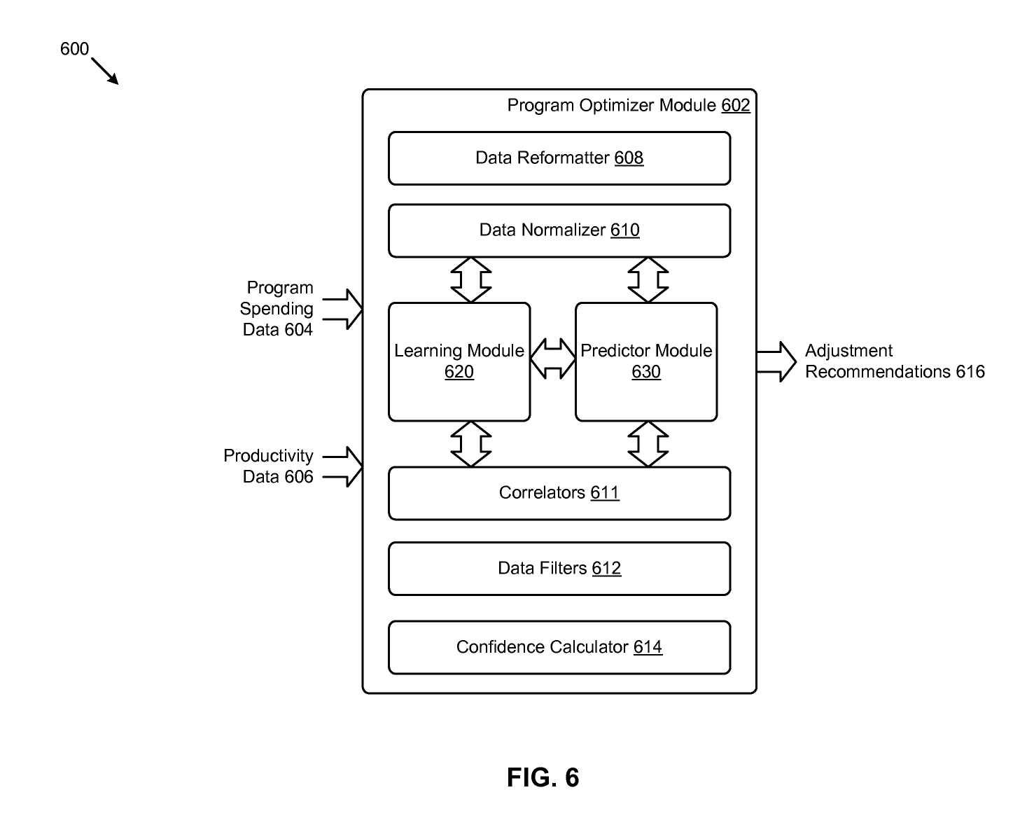

In some use cases, program reports 114 and/or features as are present in and/or interface with the environment 100 (e.g., measurable productivity, participation rates, etc.) can be used to assists a benefits manager in negotiations with benefits providers so as to reduce the cost of healthcare premiums. Such program reports can include identification of a risk pool, and management can use models, predictions, and reports to present to shareholders who might wish to explore wellness programs and verify stated justifications for the wellness program components. Embodiments of models and predictions are discussed as shown and pertaining to FIG. 6.

Now, returning to the makeup of the wellness program, such a wellness program might include any of the following:
Wellness Program Goals
Wellness Personal Security
Wellness Aggregate Security
Lifestyle Leaders Scoreboard
Wellness and Lifestyle Contests
Participation Incentive Payments
Wellness and Lifestyle Education Program
Wellness Survey and Assessments
Tracking Services Interfaces
Wellness Intelligence Subject Area
Volunteer Opportunity Registry
Personal Wellness Profile and Health Goals
Wellness Teams
Personal Activity Tracking
Personal Sleep Tracking
Personal Stress Tracking
Personal Lifestyle Tracking
Personal Nutrition Tracking
Personal Brain Trainer
Wellness Prompts and Notifications
Wellness Mentor Matching
Wellness Prescriptions

Further, in addition to individual-centric program components heretofore listed, a wellness program might include enterprise-wide, aggregated wellness tracking and correlations, which in turn might include:
Aggregate wellness and productivity measures
Aggregate healthcare costs and wellness correlation
Incentive and participation correlation modeling
Participation and healthcare cost correlation modeling
Predicted and surveyed wellness correlations
Aggregate wellness and absence correlations
Etcetera.

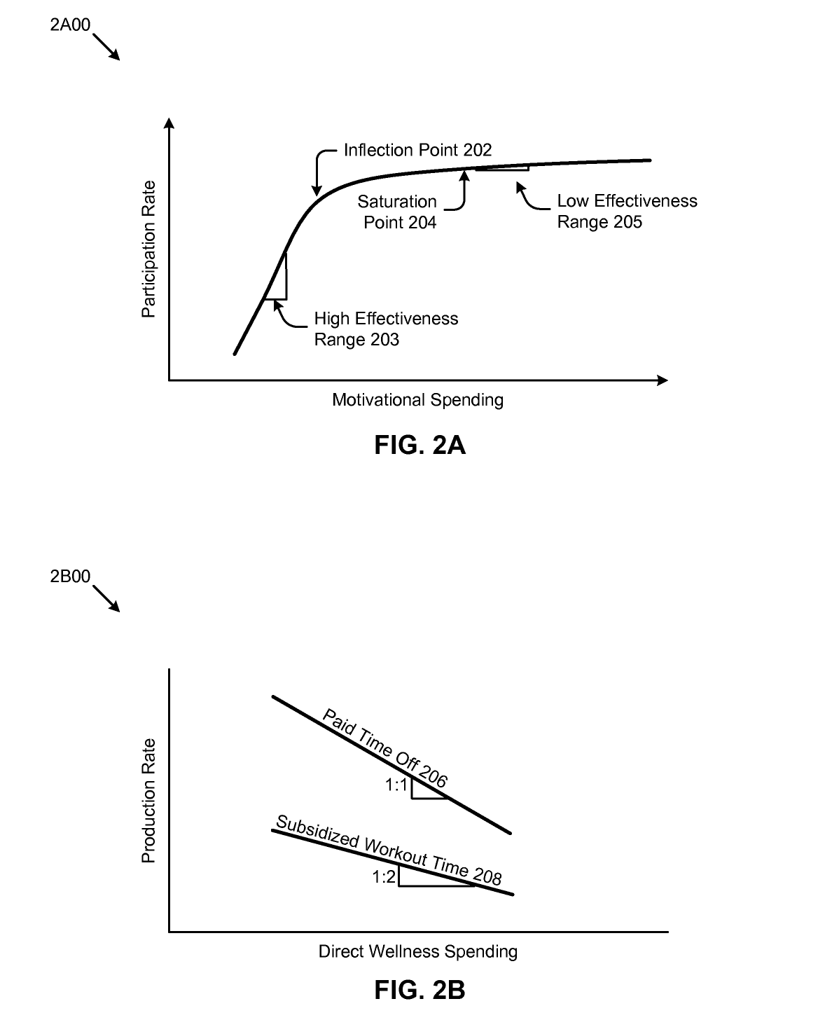

FIG. 2A is a chart 2A00 to model a participation rate as a function of motivational wellness incentive spending as used in systems for determining wellness program spending to maximize wellness program benefits. As an option, one or more instances of chart 2A00 or any aspect thereof may be implemented in the context of the architecture and functionality of the embodiments described herein. Also, the chart 2A00 or any aspect thereof may be implemented in any desired environment.

As shown in FIG. 2A, the participation rate (e.g., portion of employees who indicate a desire to engage in wellness program activities) may initially increase rapidly as initial spending on the wellness program increases (see high effectiveness range 203). At and after some inflection point 202, additional spending on the wellness program may not yield commensurately higher participation. In some cases, at some point after the inflection point, the employee pool becomes saturated with information or motivation regarding the wellness program, and additional spending may enter a low effectiveness range 205.

Motivational spending such as is depicted in FIG. 2A is merely one possibly channel for spending, and other channels for spending other than motivational spending are discussed hereunder. As one example, direct spending under a wellness program may have the effect of improving productivity. Such an example of direct spending to increase productivity is shown and discussed in the following figure.

FIG. 2B is a chart 2B00 to model productivity as a function of direct wellness incentive spending as used in systems for determining wellness program spending to maximize wellness program benefits. As an option, one or more instances of chart 2B00 or any aspect thereof may be implemented in the context of the architecture and functionality of the embodiments described herein. Also, the chart 2B00 or any aspect thereof may be implemented in any desired environment.

As shown in FIG. 2B, direct spending on a wellness program may affect productivity. For example, paid time off for wellness program activities under a wellness program may affect productivity in a one-to-one correspondence. Wellness program spending can be directly related to increasing activities and/or participation in a wellness program. Or, wellness program spending can be indirectly related to activities and/or participation. For example, and as shown, one hour of paid time off 206 appears to have the effect of merely reducing productivity by “one hour's worth” of productivity. However, although the shown spending reduces productivity by “one hour's worth” of productivity (e.g., without apparent positive correlation), such spending may yield long term benefits. In other situations, a subsidized workout time 208 for an employee (e.g., payout at say 50% of the employee's hourly rate) may reduce instantaneous productivity at a less steep slope, while still producing the desired activity that can yield long term benefits.

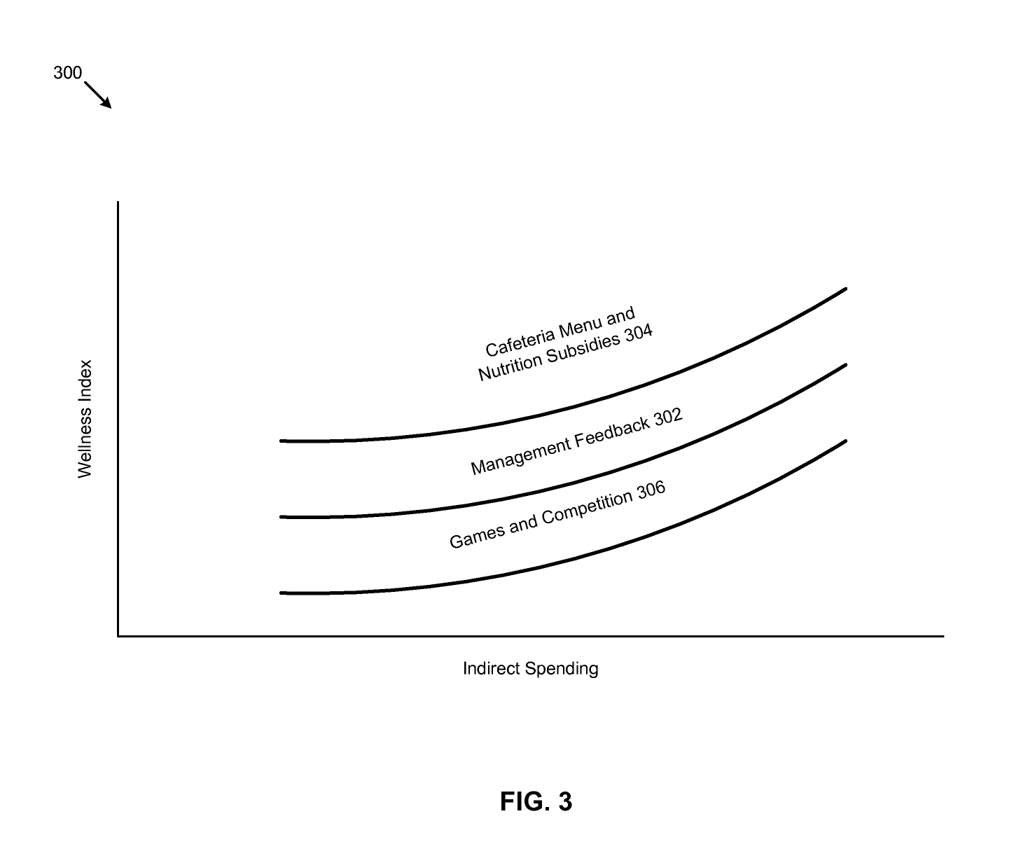

In addition to direct spending on a wellness program, there can be many forms of spending, the results of which spending can be seen in a wellness index. FIG. 3A and FIG. 3B depict a wellness index as a function of spending.

FIG. 3 is a chart 300 to model a wellness index as a function of indirect wellness incentive spending as used in systems for determining wellness program spending to maximize wellness program benefits. As an option, one or more instances of chart 300 or any aspect thereof may be implemented in the context of the architecture and functionality of the embodiments described herein. Also, the chart 300 or any aspect thereof may be implemented in any desired environment.

As shown in FIG. 3, a wellness index may be affected by indirect spending in the form of the administration of games and competition 306 and/or by ongoing sessions dedicated to management feedback 302 (e.g., management feedback to an employee as regards the employee's participation in the company's wellness program). In some cases, and as shown, indirect spending intended to improve a wellness index might come in the form of nutrition subsidies 304. For example, costs of a nutrition subsidy might come in the form of a higher-quality menu provided in the company's cafeteria.

There are cases where spending by any function in a company can serve to decrease wellness. For example, although spending on overtime might commensurately increase productivity per employee, there are wellness costs (decreases in a wellness index) that can be modeled, In other situations, certain increases in spending actually serves to reduce wellness (e.g., induce stress or induce other effects that serve to depress the employee's wellness index).

In some situations wellness program spending is a first-order effect (e.g., affecting productivity and/or affecting wellness). In other situations, and as shown in the following figures, the overall benefits attributable to the wellness program may come as a second order effect. For example, individual and/or aggregated healthcare premiums may decrease as a result of an improved wellness index, which is attributable to first order spending on a wellness program.

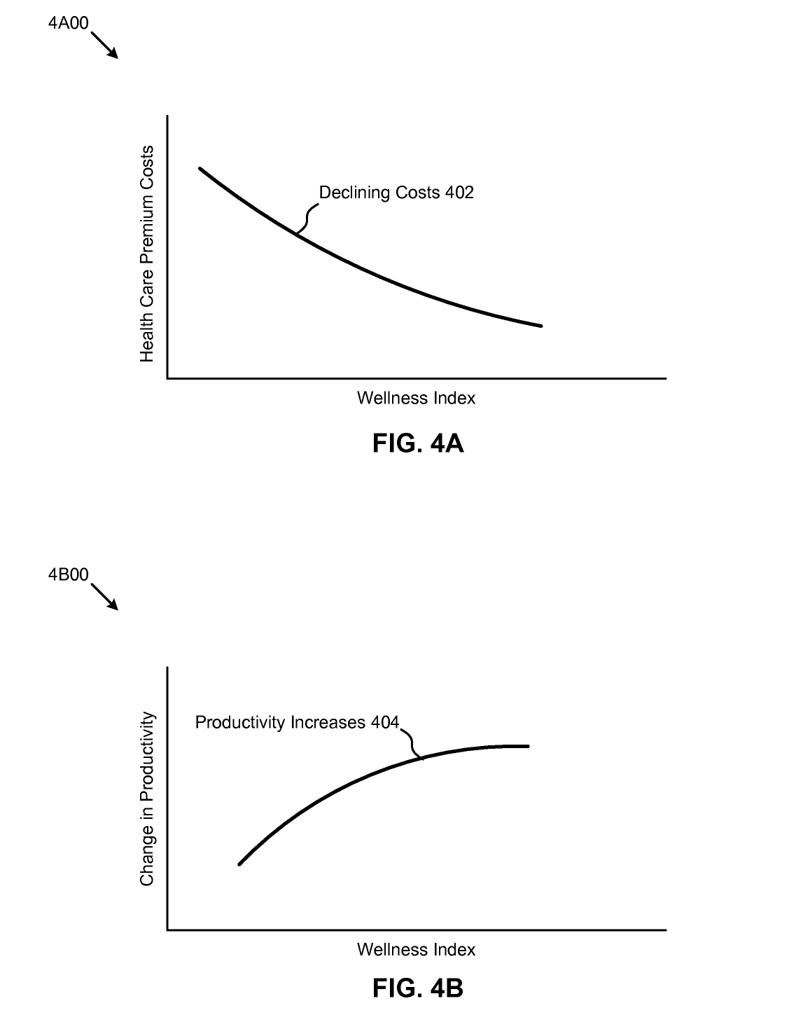

FIG. 4A is a chart 4A00 to model changing healthcare premium costs as a function of a wellness index as used in systems for determining wellness program spending to maximize wellness program benefits. As an option, one or more instances of chart 4A00 or any aspect thereof may be implemented in the context of the architecture and functionality of the embodiments described herein. Also, the chart 4A00 or any aspect thereof may be implemented in any desired environment.

As shown in FIG. 4A, healthcare premiums may decrease as the insurance carriers recognize the actuarial (e.g., long term) effects of wellness of the employee population (e.g., see declining costs 402).

FIG. 4B is a chart 4B00 to model changing employee productivity as a function of a wellness index as used in systems for determining wellness program spending to maximize wellness program benefits. As an option, one or more instances of chart 4B00 or any aspect thereof may be implemented in the context of the architecture and functionality of the embodiments described herein. Also, the chart 4B00 or any aspect thereof may be implemented in any desired environment.

As depicted by curve 404 of FIG. 4B, it can occur that productivity increases as wellness increases. For example, a worker may perform with fewer errors as his/her wellness index increases. Or, a worker might be more creative in solving problems as his/her wellness index increases and, as a consequence, his/her measurable productivity increases.

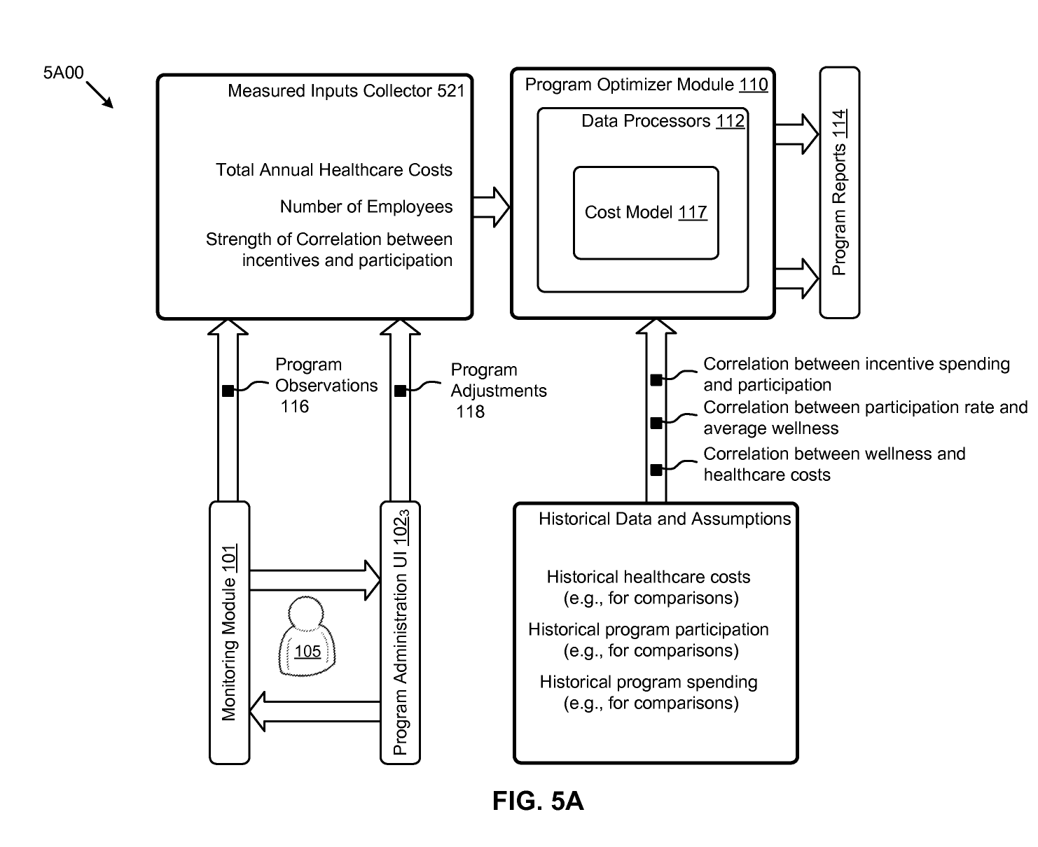

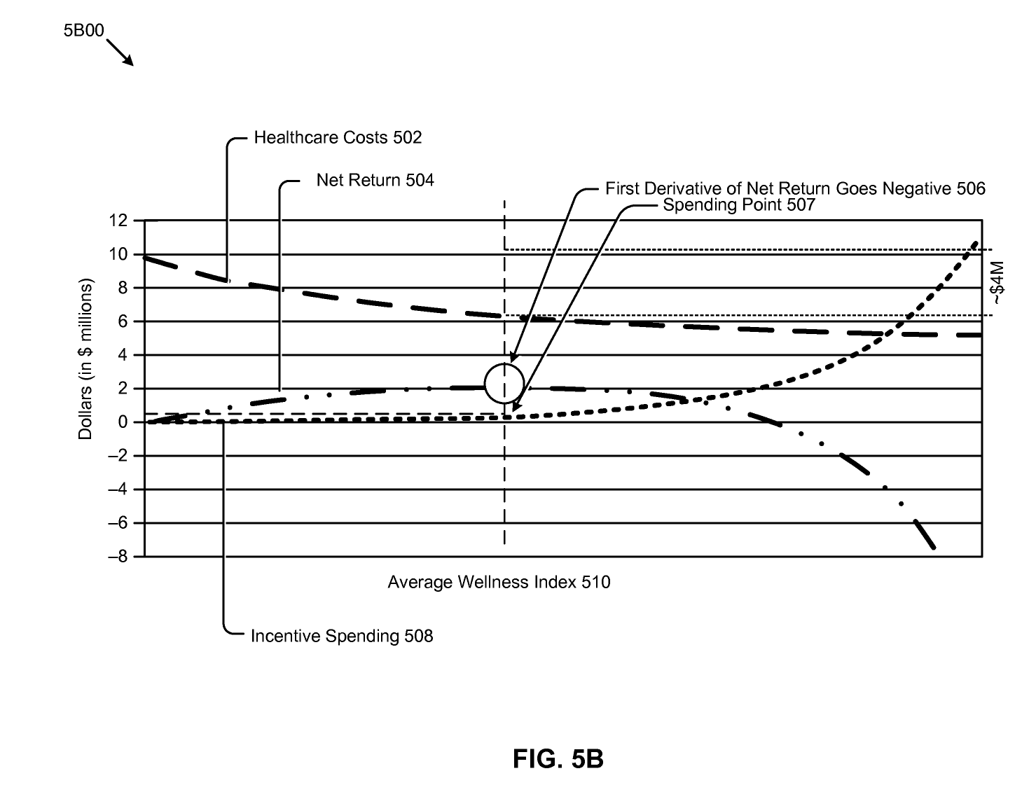

FIG. 5A is a system for calculating net return as a function of wellness program spending as used in systems for determining wellness program spending to maximize wellness program benefits.

As shown, monitoring module 101 monitors program progression, and provides measurements to a measured inputs collector 521. The measured inputs collector 521 in turn provides measurements to the cost model 117. As earlier indicated, a user such a benefits manager can make adjustments to the program variables. In the embodiment shown, a user can interact with a program administration UI 102₃ to specify and/or control values and/or usage of various wellness program-related data.

In the shown scenario, inputs into the program optimizer module 110 include:
Total Annual Healthcare costs
Number of Employees
Strength of correlation between incentives and participation.

The user can interact with a program administration UI 102₂ to set variables (e.g., incentive amounts) and the user can view renderings of program reports 114 to see variations in participation rates (e.g., with respect to incentive costs). In some cases, the program optimizer module 110 receives a set of assumptions as follows:
Relationships between incentive amounts and participation rates at various correlation levels, including decline in the rate of increase.
Relationships between participation rate and average wellness, including decline is the increase in wellbeing at higher participation rates.
Relationships between wellness and healthcare costs including the decline in the rate of spending decrease at higher levels of wellness.

In exemplary cases, the data processors 112 include simulation engines that can model program behavior over a time period, and a series of program reports 114 facilitates determination of an optimum incentive spending amount given a particular simulation scenario.

Enterprise administration of wellness programs that include incentive spending often have the effect of producing a net return to the enterprise. For example, a relatively small amount of incentive spending can result in an improvement in average wellness of the workforce, which in turn can result in lower healthcare costs borne by the enterprise. Over some ranges, additional incentive and other program spending has the effect of reducing the net costs borne by the enterprise. In some cases, additional incentive spending does not produce further participation and/or does not produce further wellness, and/or does not produce additional net lowered costs borne by the enterprise. The following chart gives an example scenario where additional wellness program spending does result in net benefits of the spending.

FIG. 5B is a chart 5B00 depicting net return as a function of wellness program spending as used in systems for determining wellness program spending to maximize wellness program benefits.

This example shows a scenario where additional wellness program spending (e.g., incentive spending 508) increases over a range. The example also shows increases in an average wellness index 510 over the same range. The dollars spent in incentives are correlated to increases in the wellness in the workforce, which is in turn correlated to reduced healthcare costs borne by the enterprise. Strictly as one example, the chart 5B00 shows a net return curve (e.g., net return 504) which can be calculated as follows:

Net Return=Reduced_Healthcare_Costs−Costs_of Wellness_Program (1)

where the net savings amount can be calculated as the quantity comprising an amount of incentive spending minus the amount of benefits resulting from the incentive spending.

The aforementioned Reduced_Healthcare_Costs and/or the amount of benefits resulting from the incentive spending can include many terms. For example, reduced healthcare costs can include any, some, or all of the following:
Reduced spending on healthcare premiums
Reduced loss of productivity based on wellness and/or sickness and/or absenteeism
Reduced spending on out-of-pocket healthcare costs, and
Reduced competitive penalties based on recruiting disadvantages of an unwell workforce.

Any of the plotted time series inputs may be a time series based on a model, and/or may be a time series based on empirically-collected data, and/or may be a time series based on interpolation and/or extrapolation, and/or may be a time series based on predictions from a model, and/or the time series can be derived from any combination of the foregoing. Moreover, in exemplary cases, plotted inputs are derived from raw data that has been normalized so as to prepare the raw data for comparison with other raw data. For example, the time series of wellness program spending (e.g., incentive spending 508) might be normalized to be in dollar units, and time series of healthcare costs (e.g., depicted as the declining curve healthcare costs 502) might also be normalized to be in dollar units. Normalization facilitates plotting on a graph, and normalization facilitates formation of an objective function that can be used in solving a minimization/maximization problem. In some scenarios, additional wellness program spending yields additional savings—to a point. That point is an optimal amount of wellness spending (possibly a local optimum), and that point can be calculated or predicted as the point at which the next unit of incremental wellness program spending no longer returns incremental net return benefits. The chart 500 shows a circle where the first derivative of net return is zero, and then goes negative 506, and the chart 500 shows a corresponding point shown as spending point 507. In the shown example, a spending amount of a few hundred thousand dollars yields a health care cost savings of roughly $4 million dollars.

FIG. 6 is a block diagram 600 depicting a program optimizer module as used in systems for determining wellness program spending to maximize wellness program benefits. As an option, one or more instances of block diagram 600 or any aspect thereof may be implemented in the context of the architecture and functionality of the embodiments described herein. Also, the block diagram 600 or any aspect thereof may be implemented in any desired environment.

As aforementioned, any of the time series inputs from which a net return curve is generated may be a time series based on a model, and/or may be a time series based on empirically-collected data, and/or may be a time series based on predictions from a model. The program optimizer module 602 uses a learning model 724 (e.g., within learning module 620) and a predictor model or simulation model (e.g., within predictor module 630). Empirical stimulation data (e.g., program spending data 604) is presented to the program optimizer module as a first set of inputs, and empirical response data (e.g., productivity data 606) is presented to the program optimizer module as a second set of inputs. Various data pre-processing is performed (e.g., see data reformatter 608 and data normalizer 610) before delivery to the learning module 620 and predictor module 630. Correlations between the first set of inputs and the second set of inputs can be calculated and the correlations used as a predictor. For example a correlator 611 can determine that the occurrence of a large increase in wellness participation in a given quarter might be a good predictor of a healthcare premium abatement in the following quarter. Such correlations can be direct correlations or inverse correlations, and/or can be correlations that include a delay from set of input observations to a correlated set of output observations, and/or correlations can be formed using any known technique. Some correlations techniques are discussed in the context of learning models, as follows.

In some cases, the results of correlators 611 might be outside of a bound or threshold of correlation and such determinations and/or results should be discarded before further processing. As shown, one or more data filters 612 serve to apply correlation conditions and/or correlation thresholds to the results of the correlators 611. In still other situations, the results of correlators 611 might be outside of a bound or threshold of a confidence level, and determinations and/or results from the correlators 611 should be assessed for confidence before further processing. As shown, one or more confidence calculators 614 serve to apply confidence conditions and/or confidence thresholds to the results of the correlators 611.

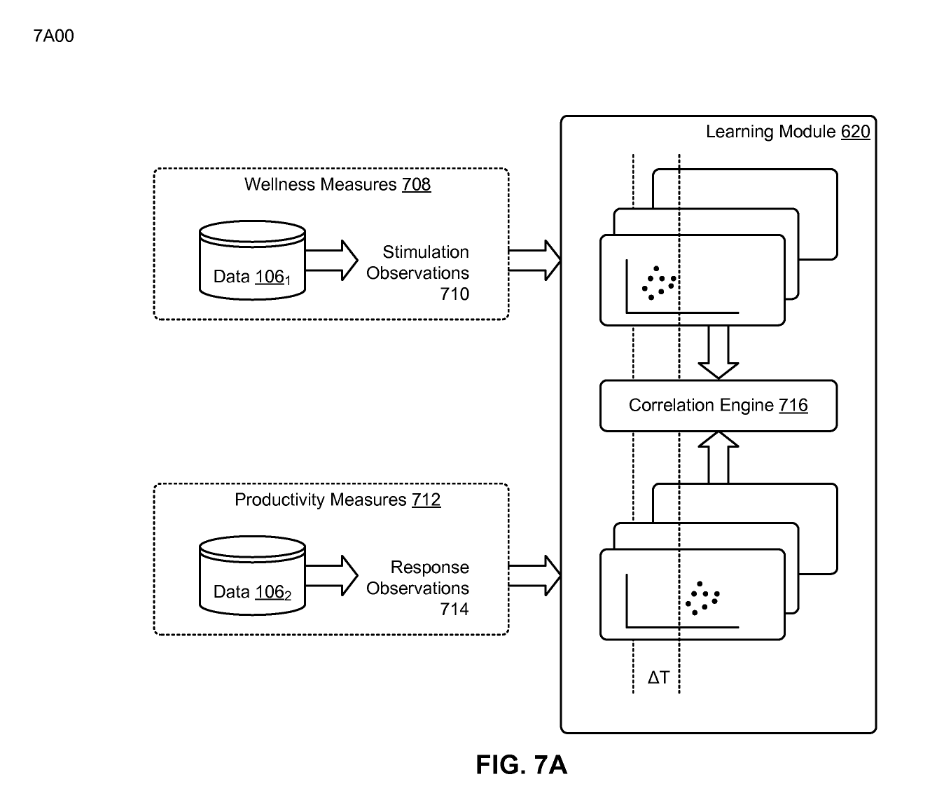

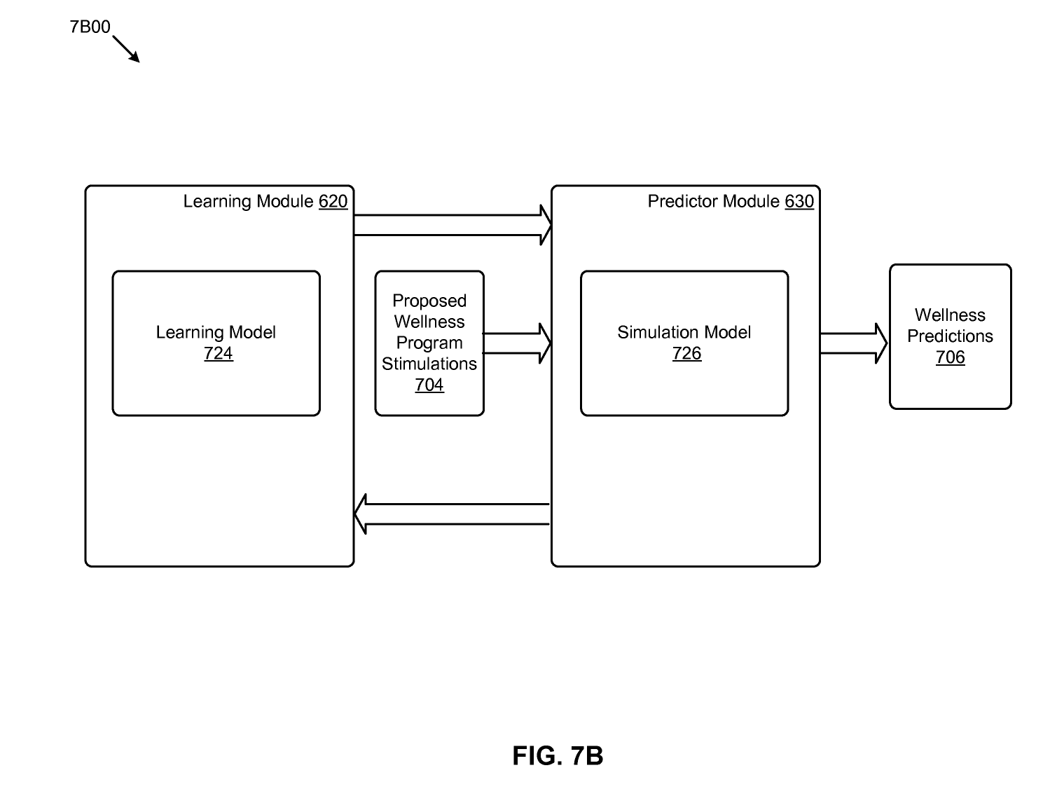

The predictor module 630 of the program optimizer module can be used as a simulator in order to produce a recommendation (e.g., adjustment recommendation 616) such that a user can make a program adjustment (e.g., a wellness program spending adjustment). In exemplary cases, the predictor module 630 uses the learning module 620, and the predictor can produce a forecast of effects or responses based on some inputs or stimulus. In turn, the predictor can produce recommended changes to be made to the wellness cost model. Strictly as one example of the foregoing, the predictor module 630 might predict that a small incremental increase in wellness motivational spending eventually results in a large incremental increase in participation rates (e.g., after a 1 week delay). A predictor module can accept an input in the form of some proposed wellness program stimulation, and the predictor module might in turn predict a corresponding response in participation, possibly including a time delay between the stimulation and measured responses. Uses of the learning module 620, and uses of the predictor module serve assist a benefits manager to experiment with a range of and/or mix of wellness spending levels. Experiments and use of predictors are further discussed as pertaining to the hereunder FIG. 7A and FIG. 7B.

FIG. 7A is a block diagram 7A00 depicting a learning module as used in systems for determining wellness program spending to maximize wellness program benefits. As an option, one or more instances of block diagram 7A00 or any aspect thereof may be implemented in the context of the architecture and functionality of the embodiments described herein. Also, the block diagram 7A00 or any aspect thereof may be implemented in any desired environment.

The learning module 620 of FIG. 7A is a specific embodiment that includes a correlation engine 716 to compare a first set of data points (e.g., wellness measures 708) to a second set of data points (e.g., productivity measures 712). In some models, the first set of data points comprise a set of time-series data points that are stimulation observations 710, and the second set of data points are time-series data points that are response observations 714. The correlation engine 716 can correlate stimulus to response, and can determine a time lag (e.g., ΔT) between stimulus and response, and can handle direct correlations, inverse correlations, and any other known-in-the-art correlations. Further discussion of techniques for forming correlation and positing causality are described in U.S. patent application Ser. No. ______, entitled “FORMING RECOMMENDATIONS USING CORRELATIONS BETWEEN WELLNESS AND PRODUCTIVITY” (Attorney Docket No. ORA140676-US-NP), filed on even date herewith, which is hereby incorporated by reference in its entirety.

When learning module 620 has generated a learning model 724, a predictor module can form a simulation model 726, which can be used to generate predictions of future events as responses to proposed stimulations.

FIG. 7B is a block diagram 7B00 depicting a simulation model-based predictor as used in systems for determining wellness program spending to maximize wellness program benefits. As an option, one or more instances of block diagram 7B00 or any aspect thereof may be implemented in the context of the architecture and functionality of the embodiments described herein. Also, the block diagram 7B00 or any aspect thereof may be implemented in any desired environment.

The shown learning model 724 comprises data within learning module 620 forms the basis for a simulation model 726 used within predictor module 630. In this embodiment, the learning module 620 has pre-calculated correlations between stimuli and responses such that a given proposed stimulation (e.g., proposed wellness program stimulations 704) can drive the simulation model 726 so as to output wellness predictions 706. Strictly as one example, a benefits manager might want to increase motivational spending by 25% in the hope or expectation of gaining greater participation. The predictor module takes in the proposed wellness program stimulation (e.g., 25% more motivational spending) and produces a prediction.

### Additional Embodiments of the Disclosure

### Additional Practical Application Examples

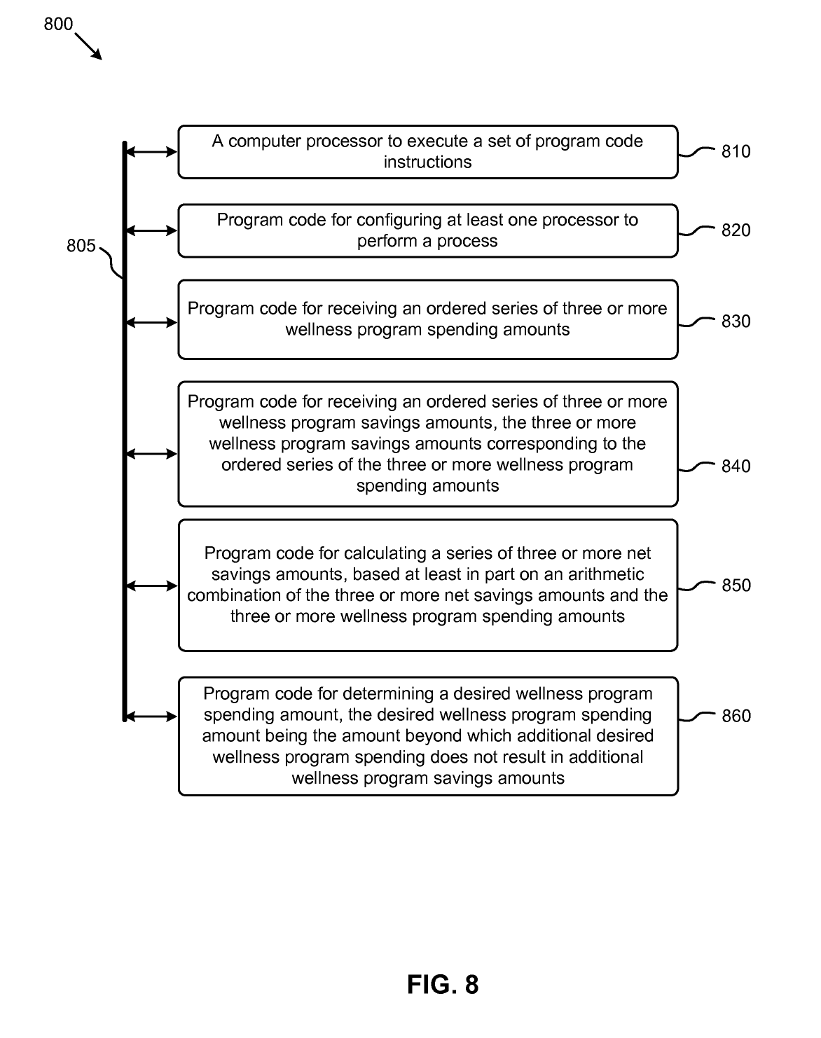

FIG. 8 is a block diagram of a system for determining wellness program spending to maximize wellness program benefits, according to some embodiments. FIG. 8 depicts a block diagram of a system to perform certain functions of a computer system. As an option, the present system 800 may be implemented in the context of the architecture and functionality of the embodiments described herein. Of course, however, the system 800 or any operation therein may be carried out in any desired environment. As shown, system 800 comprises at least one processor and at least one memory, the memory serving to store program instructions corresponding to the operations of the system. As shown, an operation can be implemented in whole or in part using program instructions accessible by a module. The modules are connected to a communication path 805, and any operation can communicate with other operations over communication path 805. The modules of the system can, individually or in combination, perform method operations within system 800. Any operations performed within system 800 may be performed in any order unless as may be specified in the claims. The embodiment of FIG. 8 implements a portion of a computer system, shown as system 800, comprising a computer processor to execute a set of program code instructions (see module 810) and modules for accessing memory to hold program code instructions to perform: using a computing system having at least one processor to perform at least some steps of a process, the process comprising (see module 820); receiving an ordered series of three or more wellness program spending amounts (see module 830); receiving an ordered series of three or more wellness program return on wellness program spending amounts, the three or more wellness program return on wellness program spending amounts corresponding to the ordered series of the three or more wellness program spending amounts (see module 840); calculating a series of three or more net return amounts, based at least in part on an arithmetic combination of the three or more net return amounts and the three or more wellness program spending amounts (see module 850); and determining a desired wellness program spending amount, the desired wellness program spending amount being the amount beyond which additional desired wellness program spending does not result in additional wellness program return on wellness program spending amounts (see module 860).

Some embodiments can produce recommendations. For example, some embodiments receive prospective wellness program spending amounts that are used to produce recommended wellness program spending adjustments. In some cases the recommendation is based on a learning model 724 and simulation model 726 formed by correlating a series of wellness program spending amounts wellness program return on wellness program spending amounts. Correlations between two or more series can be based on comparisons of time-ordered series. For example, a time-ordered series can comprise wellness program spending amounts in the form of motivational spending amounts, a paid time off amounts, a subsidized workout time amounts, cafeteria menu subsidy amounts and so on. Correlations between two or more series can be based on comparisons of wellness program stimulations (e.g., spending) and wellness program results (e.g., healthcare cost savings amounts, savings amounts based on increased production, etc.). Correlations might be determined after adjusting for a time delay between a particular stimulation and the time when correlated measurements are observed.

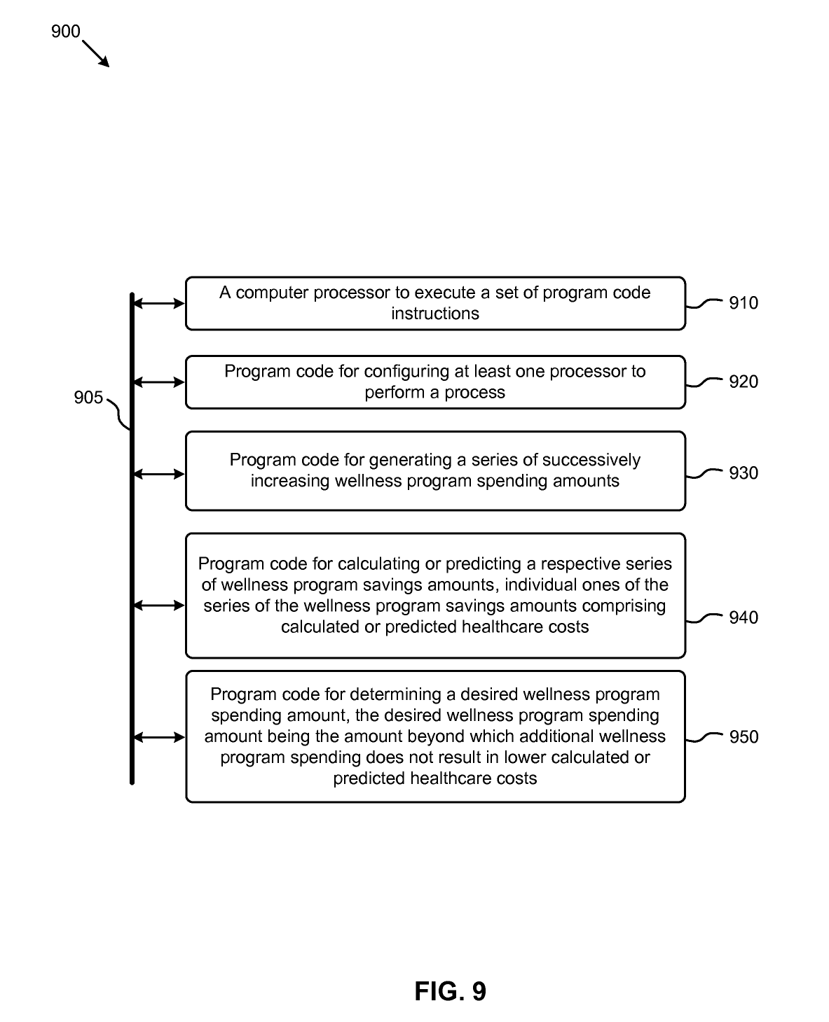

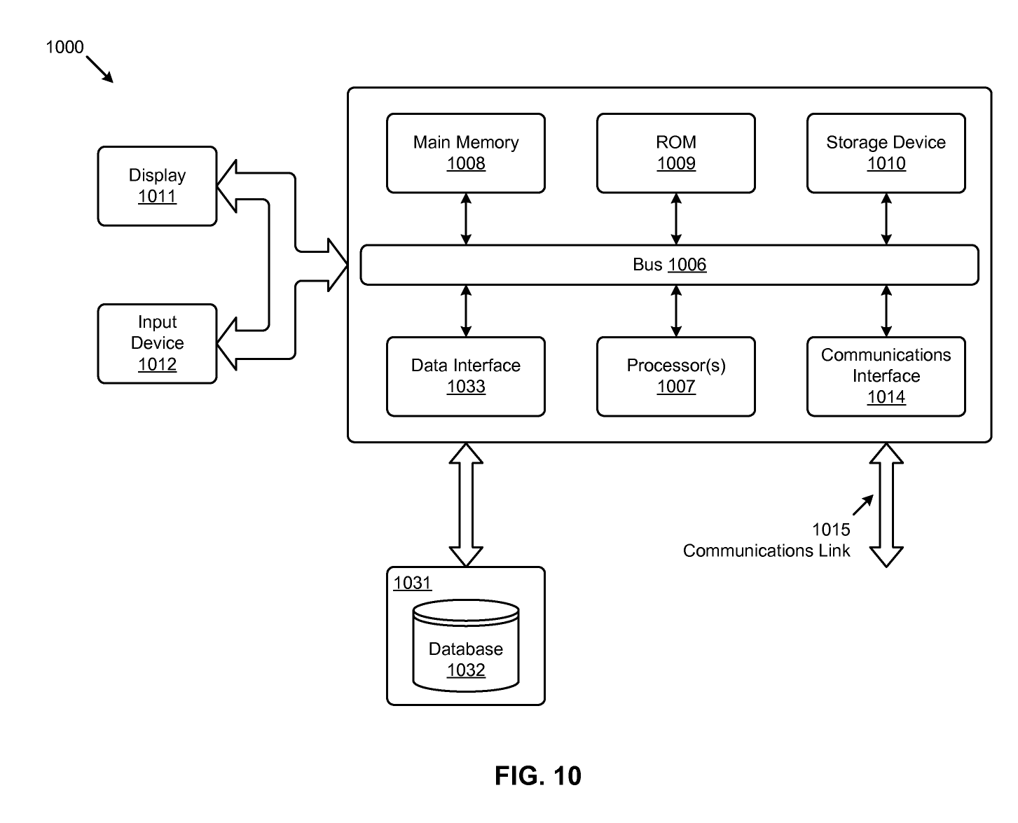

FIG. 9 is a block diagram of a system for determining wellness program spending to maximize wellness program benefits, according to some embodiments. FIG. 9 depicts a block diagram of a system to perform certain functions of a computer system. As an option, the present system 900 may be implemented in the context of the architecture and functionality of the embodiments described herein. Of course, however, the system 900 or any operation therein may be carried out in any desired environment. As shown, system 900 comprises at least one processor and at least one memory, the memory serving to store program instructions corresponding to the operations of the system. As shown, an operation can be implemented in whole or in part using program instructions accessible by a module. The modules are connected to a communication path 905, and any operation can communicate with other operations over communication path 905. The modules of the system can, individually or in combination, perform method operations within system 900. Any operations performed within system 900 may be performed in any order unless as may be specified in the claims. The embodiment of FIG. 9 implements a portion of a computer system, shown as system 900, comprising a computer processor to execute a set of program code instructions (see module 910) and modules for accessing memory to hold program code instructions to configure a computing system (see module 920), the computing system having at least one processor to perform at least some steps of a process, the process comprising: generating a series of successively increasing wellness program spending amounts (see module 930); calculating or predicting a respective series of wellness program savings amounts, wherein individual ones of the series of the wellness program savings amounts comprising calculated or predicted healthcare costs (see module 940); and determining a desired wellness program spending amount, the desired wellness program spending amount being the amount beyond which additional wellness program spending does not result in lower calculated or predicted healthcare costs (see module 930). Some embodiments use the determined wellness program spending amount to produce a recommended wellness program spending adjustment.

### System Architecture Overview

### Additional System Architecture Examples

FIG. 10 depicts a block diagram of an instance of a computer system 1000 suitable for implementing an embodiment of the present disclosure. Computer system 1000 includes a bus 1006 or other communication mechanism for communicating information, which interconnects subsystems and devices, such as a processor 1007, a system memory 1008 (e.g., RAM), a static storage device (e.g., ROM 1009), a disk drive 1010 (e.g., magnetic or optical), a data interface 1033, a communication interface 1014 (e.g., modem or Ethernet card), a display 1011 (e.g., CRT or LCD), input devices 1012 (e.g., keyboard, cursor control), and an external data repository 1031.

According to one embodiment of the disclosure, computer system 1000 performs specific operations by processor 1007 executing one or more sequences of one or more instructions contained in system memory 1008. Such instructions may be read into system memory 1008 from another computer readable/usable medium, such as a static storage device or a disk drive 1010. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 1007 for execution. Such a medium may take many forms, including but not limited to, non-volatile media and volatile media. Non-volatile media includes, for example, optical or magnetic disks, such as disk drive 1010. Volatile media includes dynamic memory, such as system memory 1008.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 1000. According to certain embodiments of the disclosure, two or more computer systems 1000 coupled by a communications link 1015 (e.g., LAN, PTSN, or wireless network) may perform the sequence of instructions required to practice the disclosure in coordination with one another.

Computer system 1000 may transmit and receive messages, data, and instructions, including programs (e.g., application code), through communications link 1015 and communication interface 1014. Received program code may be executed by processor 1007 as it is received and/or stored in disk drive 1010 or other non-volatile storage for later execution. Computer system 1000 may communicate through a data interface 1033 to a database 1032 on an external data repository 1031. Data items in database 1032 can be accessed using a primary key (e.g., a relational database primary key). A module as used herein can be implemented using any mix of any portions of the system memory 1008, and any extent of hard-wired circuitry including hard-wired circuitry embodied as a processor 1007.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A method comprising:
identifying a computing system having a storage subsystem, wherein the storage subsystem comprises at least a database area having a series of records stored on a computer-readable medium, where individual records are accessed using at least a primary key and at least some of the records serve to store data points;
retrieving, from the database area, a set of wellness program spending amount data points to generate a series of successively increasing wellness program spending amounts wherein the wellness program spending amounts are historical amounts or prospective amounts;
calculating or predicting, using the computing system, a respective series of wellness program savings amounts, wherein individual ones of the series of the wellness program savings amounts comprising calculated or predicted healthcare costs; and
determining a desired wellness program spending amount, the desired wellness program spending amount being the amount at which point an incremental amount of additional wellness program spending results in an equal or lesser amount of incremental calculated or predicted wellness program savings.

2. The method of claim 1, wherein the desired wellness program spending amount is a point where a first derivative of a net savings amount is zero.

3. The method of claim 1, further comprising using the desired wellness program spending amount to produce a recommended wellness program spending adjustment.

4. The method of claim 3, further comprising calculating a wellness index change corresponding to the recommended wellness program spending adjustment.

5. The method of claim 1, wherein at least some of the series of successively increasing wellness program spending amounts comprise at least one of, a motivational spending amount, a paid time off amount, a subsidized workout time amount, a cafeteria menu subsidy amount, and an employee healthcare cost-sharing amount.

6. The method of claim 1, wherein at least some of the respective series of wellness program savings amounts comprises a healthcare premium cost savings amount.

7. The method of claim 1, wherein at least some of the respective series of wellness program savings amounts comprises a savings amount based at least in part on increased production.

8. The method of claim 1, further comprising generating a learning model based at least in part on historical data to correlate observed productivity measures to wellness-attributed stimulation.

9. The method of claim 8, wherein the learning model is used as a predictor in a simulation engine.

10. The method of claim 1, further comprising simulating one or more proposed wellness program spending stimulations to predict a corresponding change in a wellness index.

11. The method of claim 10, further comprising using the change in the wellness index to predict a corresponding change in healthcare premium costs.

12. A computer program product embodied in a non-transitory computer readable medium, the computer readable medium having stored thereon a sequence of instructions which, when executed by a processor causes the processor to execute a process, the process comprising:
retrieving a set of wellness program spending amount data points to generate a series of successively increasing wellness program spending amounts wherein the wellness program spending amounts are historical amounts or prospective amounts;
calculating or predicting a respective series of wellness program savings amounts, wherein individual ones of the series of the wellness program savings amounts comprising calculated or predicted healthcare costs; and
determining a desired wellness program spending amount, the desired wellness program spending amount being the amount at which point an incremental amount of additional wellness program spending results in an equal or lesser amount of incremental calculated or predicted wellness program savings.

13. The computer program product of claim 12, wherein the desired wellness program spending amount is a point where a first derivative of a net savings amount is zero.

14. The computer program product of claim 12, further comprising program code for using the desired wellness program spending amount to produce a recommended wellness program spending adjustment.

15. The computer program product of claim 12, wherein at least some of the series of successively increasing wellness program spending amounts comprise at least one of, a motivational spending amount, a paid time off amount, a subsidized workout time amount, a cafeteria menu subsidy amount, and an employee healthcare cost-sharing amount.

16. The computer program product of claim 12, wherein at least some of the respective series of wellness program savings amounts comprises a healthcare premium cost savings amount.

17. The computer program product of claim 12, wherein at least some of the respective series of wellness program savings amounts comprises a savings amount based at least in part on increased production.

18. The computer program product of claim 12, further comprising program code for generating a learning model based at least in part on historical data to correlate observed productivity measures to wellness-attributed stimulation.

19. A system comprising:
a database engine to retrieve, a set of wellness program spending amount data points to generate a series of successively increasing wellness program spending amounts wherein the wellness program spending amounts are historical amounts or prospective amounts;
a data processor to calculate or predict a respective series of wellness program savings amounts, wherein individual ones of the series of the wellness program savings amounts comprising calculated or predicted healthcare costs; and
a program optimizer module to determine a desired wellness program spending amount, the desired wellness program spending amount being the amount at which point an incremental amount of additional wellness program spending results in an equal or lesser amount of incremental calculated or predicted wellness program savings.

20. The system of claim 19, wherein the desired wellness program spending amount is a point where a first derivative of a net savings amount is zero.
